(19) United States
(12) Patent Application Publication
(10) Pub. No.: US 2017/0035109 A1
(43) Pub. Date: Feb. 9, 2017

(54) ATOMIZER AND ELECTRONIC CIGARETTE

(71) Applicant: KIMREE HI-TECH INC., Tortola (VG)

(72) Inventor: Qiuming LIU, Huizhou, Guangdong (CN)

(21) Appl. No.: 14/766,790

(22) PCT Filed: Apr. 23, 2014
(86) PCT No.: PCT/CN2014/076004

§ 371 Date: Aug. 10, 2015

(30) Foreign Application Priority Data
Apr. 3, 2014 (CN) 201420161302.2

(51) Int. Cl. A24F 47/00; F22B 1/28; H05B 1/02

(52) U.S. Cl. CPC A24F 47/008; H05B 1/0244; F22B 1/285; H05B 2203/021

(57) ABSTRACT

An atomizer and an electronic cigarette are provided. The atomizer includes: an atomizer cartridge; a liquid storage area arranged inside the atomizer cartridge; an electric heating element coiled spirally to form a plate-shape structure; and a first liquid guide cloth. The first liquid guide cloth is arranged covering an opening of the liquid storage area, and the electric heating element is laid on a side of the first liquid guide cloth away from the liquid storage area. With the first liquid guide cloth, the quantity of the cigarette liquid transferred to the electric heating element is ensured to be equable. The electric heating element is arranged along the transverse direction of the atomizer, thereby avoiding conventional problems of non-uniform smoke volume and burning-out of the liquid storage cotton due to gravity or vibration of the spiral coils.

### CROSS-REFERENCED APPLICATIONS

This application is the national phase of International Application No. PCT/CN2014/076004, titled “ATOMIZER AND ELECTRONIC CIGARETTE”, filed on Apr. 23, 2014, which claims the benefit of priority to Chinese Patent Application No. 201420161302.2, titled “ATOMIZER AND ELECTRONIC CIGARETTE”, filed with the State Intellectual Property Office of the PRC on Apr. 3, 2014, the entire disclosure of which are incorporated herein by reference.

### BACKGROUND

1. Field of the Disclosure

The present application relates to the technical field of electronic cigarettes, and particularly to an atomizer which effectively increases smoke volume and an electronic cigarette.

2. Discussion of the Background Art

Reference is made to FIG. 1 for the structure of a conventional atomizer. As illustrated in FIG. 1, the atomizer is for atomizing a cigarette liquid to generate a smoke for being inhaled by a user. In a specific arrangement, a glass fiber tube 102 is provided inside an atomizer cartridge 105, and a liquid storage cotton 101 for storing the cigarette liquid is coated at the outside of the glass fiber tube 102. A glass fiber wire 103 is provided inside the glass fiber tube 102. The glass fiber wire 103 has two ends passing through the glass fiber tube 102 and inserted into the liquid storage cotton 101, and an electric heating wire 104 in a column shape is wound around the glass fiber wire 103, the electric heating wire being for atomizing the cigarette liquid. An axis direction of electric heating wire 104 is perpendicular to an axis direction of the atomizer. The cigarette liquid inside the liquid storage cotton 101 can be transferred to the electric heating wire 104 via the glass fiber tube 102 and the glass fiber wire 103, and accordingly, the electric heating wire 104 atomizes the cigarette liquid to generate the smoke.

Currently, the electric heating wire 104 has a diameter ranging from 0.08 mm to 0.13 mm, which is small, such that a contact area of the electric heating wire 104 in contact with the glass fiber wire 103 is small. The atomizing temperature of the cigarette liquid ranges from 220 Celsius degrees to 300 Celsius degrees. For increasing the smoke volume to meet the requirement of a user with a big vital capacity, the current flowing through the electric heating wire 104 is increased to enable the electric heating wire 104, when energized, to reach a temperature ranging from 300 Celsius degrees to 600 Celsius degrees. However, such approach is apt to cause the liquid storage cotton 101 to be burnt, which negatively affects the service life of the electronic cigarette. Furthermore, increasing the smoke volume may also be achieved by increasing the length of the electric heating wire 104. However, since the electronic cigarette is primarily for imitating a tobacco cigarette, it is preferred to have a size equal to that of the tobacco cigarette so that it is readily accepted by a user; hence, transverse section areas of the electronic cigarette and the glass fiber tube 102 inside the electronic cigarette are limited, the electric heating wire 104 can be lengthened in a limited scope, and accordingly, the smoke volume can be increased in a limited scope as well through lengthening the electronic heating wire 104. In addition, if the electric heating wire 104 is too long, the cigarette liquid is likely not to be transferred to the center position of the electric heating wire 104, the cigarette liquid is atomized only by both ends of the electric heating wire 104, and consequently, the electric heating wire 104 at the center position is extremely likely to be burnt out.

In the conventional technology, for increasing the smoke volume, the electric heating wire 104 wound in a column shape may be longitudinally arranged, such that the axis of the electric heating wire 104 overlaps or is parallel to the axis of the atomizer. However, since the electric heating wire 104 is of soft nature and the electric heating wire 104 arranged by winding has spaces formed between spiral coils, if the electric heating wire is placed vertically, the spiral coils may be extremely likely to contact with each other due to gravity or vibration, such that power of the electric heating wire fluctuates largely, and further causing the smoke volume to fluctuate largely, i.e., as the number of the spiral coils in contact with each other varies, the generated smoke volume varies, resulting in an unstable smoke volume. When the power is too big, the glass fiber wire 103 may be burnt; therefore, the desirable effect may not be achieved, the service life of the atomizer may be negatively affected, and reject ratio of products during manufacture is high.

### SUMMARY

In view of the above, an atomizer which may effectively increase the smoke volume and an electronic cigarette are provided in the present application.

An atomizer includes: an atomizer cartridge; a liquid storage area which is arranged inside the atomizer cartridge and is used to store a cigarette liquid; an electric heating element which is used to atomize the cigarette liquid to generate smoke and is coiled spirally to form a plate-shape structure; and a first liquid guide cloth used to transfer the cigarette liquid to the electric heating element to be atomized;

where the first liquid guide cloth is arranged covering an opening of the liquid storage area, the electric heating element is laid on a side of the first liquid guide cloth, the side of the first liquid guide cloth being away from the liquid storage area, and the electric heating element is arranged along a transverse direction of the atomizer.

In the atomizer, a second liquid guide cloth is further provided at a side of the electric heating element, the side of the electric heating element being away from the first liquid guide cloth, the second liquid guide cloth covers the electric heating element, and the second liquid guide cloth abuts against the first liquid guide cloth and is used to transfer the cigarette liquid to the electric heating element to be atomized.

In the atomizer, the liquid storage area includes;

a liquid storage chamber, which is arranged inside the atomizer cartridge and is used to contain the cigarette liquid;

a liquid separation plate, which is arranged at an opening of the liquid storage chamber and is provided with a first through hole; and

a first liquid storage cotton, which is arranged covering the liquid separation plate and is used to lock the cigarette liquid to prevent the cigarette liquid inside the liquid storage chamber from being overly transferred to the electric heating element; where the first liquid storage cotton is a sheet structure arranged along the transverse direction of the atomizer, and the first liquid guide cloth is arranged on a side face of the first liquid storage cotton, the side face of the first liquid storage cotton being away from the liquid separation plate, or,

a second liquid storage cotton, which is accommodated inside the atomizer cartridge and is used to store the cigarette liquid, where the first liquid guide cloth is arranged covering an end face of the second liquid storage cotton, the end face of the second liquid storage cotton being close to the electric heating element.

The atomizer further includes:

a substrate made of a heat resistive material, where the substrate abuts against a side of the first liquid guide cloth, the side of the first liquid guide cloth being away from the liquid storage area;

where the substrate has a side provided with a metal layer formed by printing or electroplating a metallic material on the substrate and serving as the electric heating element.

In the atomizer, the metal layer is an alloy layer made of multiple metallic materials.

In the atomizer,

the alloy layer is provided at a side of the substrate, the side of the substrate being close to the liquid storage area;

the alloy layer is provided with an air hole for flowing of the smoke; and

the substrate is provided with a second through hole at a position corresponding to that of the air hole.

In the atomizer,

the alloy layer is provided at a side of the substrate, the side of the substrate being away from the liquid storage area;

the substrate is provided with a liquid permeating hole at a position corresponding to that of the alloy layer, where the liquid permeating holes are for transferring the cigarette liquid to the electric heating element.

The atomizer further includes:

a first outer electrode inserted in the atomizer cartridge;

an insulation ring arranged inside the first outer electrode; and

a first inner electrode inserted inside the insulation ring;

where the electric heating element has one end inserted between the first outer electrode and the insulation ring, and another end inserted between the first inner electrode and the insulation ring.

In the atomizer, distances from respective spiral coils of the electric heating element to the liquid storage area gradually decrease from an innermost spiral coil of the electric heating element to an outermost spiral coil of the electric heating element.

In the atomizer, the atomizer cartridge is made of a non-metallic material, an annular protrusion is provided on a circumferential surface of an inner wall of the atomizer cartridge, and a groove matching the protrusion is provided on an outer circumferential surface of the first outer electrode at a position corresponding to that of the protrusion.

In the atomizer, the substrate is a flexible printed circuit board or a ceramic board.

In the atomizer, at least one of the first liquid guide cloth and the second liquid guide cloth is a glass fiber cloth made of a glass fiber material.

An electronic cigarette includes an electronic cigarette body; where

the electronic cigarette body is provided with a suction end, any atomizer as describe above, and a battery rod assembly for supplying power for the atomizer; and

the battery rod assembly is arranged at an end of the electronic cigarette body, the end of the electronic cigarette body being away from the suction end; or the atomizer is arranged at an end of the electronic cigarette body, the end of the electronic cigarette body being away from the suction end.

In the electronic cigarette,

the atomizer is coaxially arranged with the battery rod assembly, and the atomizer is detachably connected with the battery rod assembly.

In the electronic cigarette, the battery rod assembly includes:

a battery cartridge;

a battery accommodated inside the battery cartridge;

a second outer electrode and a second inner electrode respectively electrically connected with the battery, where the second outer electrode is electrically connected with the first outer electrode, and the second inner electrode is electrically connected with the first inner electrode;

a sensor module used to generate a triggering signal in response to an operation of the user; and

a microcontroller which is electrically connected with the sensor module and is used to generate a control signal based on the triggering signal, where the microcontroller controls, through the control signal, the battery to supply power for the electric heating element.

In the electronic cigarette,

the suction end is formed by an extension of one end of the atomizer, the end of the atomizer being away from the battery rod assembly; or,

the suction end is detachably connected to one end of the atomizer, the end of the atomizer being away from the battery rod assembly.

In the electronic cigarette,

the suction end is formed by an extension of one end of the battery rod assembly, the end of the battery rod assembly being away from the atomizer; or,

the suction end is detachably connected to one end of the battery rod assembly, the end of the battery rod assembly being away from the atomizer.

An atomizer and an electronic cigarette are provided in the present application. The atomizer includes: an atomizer cartridge; a liquid storage area which is arranged inside the atomizer cartridge and is for storing the cigarette liquid; an electric heating element which is for atomizing the cigarette liquid to generate smoke and is coiled spirally to form a plate-shape structure; and a first liquid guide cloth. The first liquid guide cloth is arranged covering an opening of the liquid storage area, and the electric heating element is laid on a side of the first liquid guide cloth away from the liquid storage area and is arranged along a transverse direction of the atomizer. Since in the application, the atomizer is provided with the first liquid guide cloth; with arrangement of the first liquid guide cloth, the quantity of the cigarette liquid transferred to the electric heating element is ensured to be equable, the volume of the smoke generated by atomization of the electric heating element is equable and constant, and the experience of the user in inhaling the smoke is improved. In addition, the spiral electric heating element is coiled to form a plate-shape structure, which effectively increases the length of the electric heating element and the contact area between the electric heating element and the first glass fiber cloth; and the electric heating element is arranged along the transverse direction of the atomizer, thereby avoiding the non-uniform smoke volume and burning-out of the liquid storage cotton due to gravity or vibration of the spiral coils in the conventional technology, such that the atomizer according to the present application, while increasing the smoke volume in a large degree, may not have the components such as the liquid storage cotton getting burnt out, effectively ensures the service life and use safety of the atomizer, and increases the yield rate of the products.

### BRIEF DESCRIPTION OF THE DRAWINGS

For more clearly illustrating technical solutions according to embodiments of the present application or conventional technologies, drawings used to describe the embodiments or the conventional technologies are briefly introduced hereinafter. Apparently, the drawings in the following description are only for a part of the embodiments of the present application, and the person skilled in the art can obtain other drawings based on these described drawings without any creative efforts.

FIG. 1 is a schematic sectional view of a conventional atomizer;

FIG. 2 is a schematic sectional view of an atomizer according to a preferred embodiment of the present application;

FIG. 3 is a schematic exploded view showing a connection structure of an atomizer according to a preferred embodiment of the present application;

FIG. 4 is a schematic view of an electric heating element of an atomizer according to a preferred embodiment of the present application;

FIG. 5 is a schematic sectional view of an atomizer according to a preferred embodiment of the present application;

FIG. 6 is a schematic sectional view of an atomizer according to a preferred embodiment of the present application;

FIG. 7 is a schematic view of an electric heating element of an atomizer according to a preferred embodiment of the present application;

FIG. 8 is a schematic view of an electric heating element of an atomizer according to a preferred embodiment of the present application;

FIG. 9 is a schematic view of an electric heating element of an atomizer according to a preferred embodiment of the present application;

FIG. 10 is a schematic view of an electric heating element of an atomizer according to a preferred embodiment of the present application;

FIG. 11 is a schematic exploded view showing a connection structure of an atomizer according to a preferred embodiment of the present application;

FIG. 12 is a schematic view showing an overall structure of an electronic cigarette according to a preferred embodiment of the present application; and

FIG. 13 is a schematic sectional view of an electronic cigarette according to a preferred embodiment of the present application.

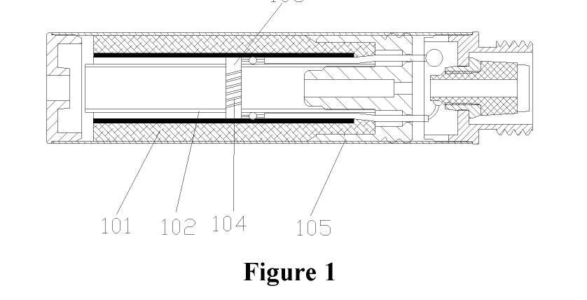

### DETAILED DESCRIPTION OF THE PREFERRED EMBODIMENT

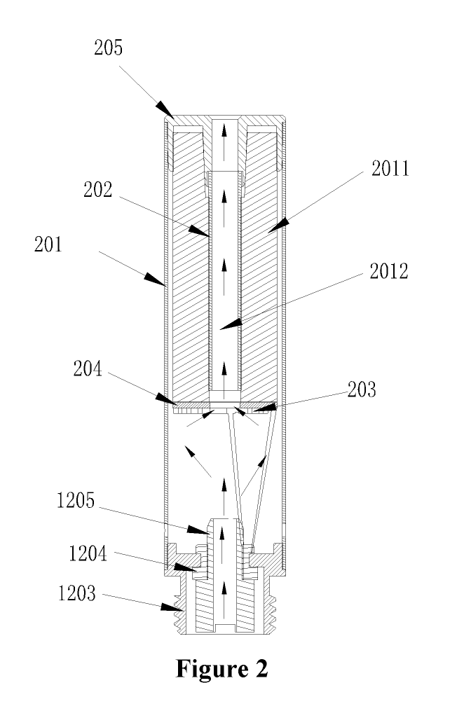

An electronic cigarette is provided in the present application, and reference may be made to FIG. 2 for a structure of the electronic cigarette.

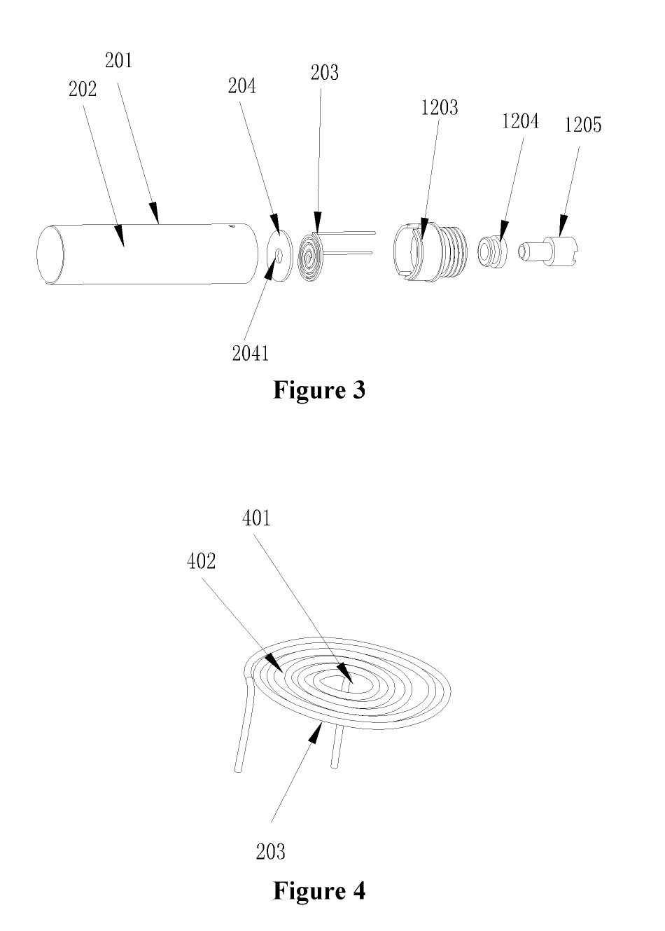

In a first embodiment, an atomizer is provided. Reference may be made to FIGS. 2 and 3 for a structure of the atomizer.

FIG. 2 is a schematic sectional of an atomizer provided in the present application, and FIG. 3 is a schematic exploded view showing a connection structure of the atomizer provided in the present application.

The atomizer includes: an atomizer cartridge 201, a liquid storage area 202, an electric heating element 203, and a first liquid guide cloth 204.

The liquid storage area 202 for storing a cigarette liquid is arranged inside the atomizer cartridge.

That is, the cigarette liquid can be sealedly stored inside the liquid storage area 202.

Specifically, reference may be made to a second embodiment for a specific structure of the liquid storage area 202, which is not described in this embodiment. The liquid storage area 202 may be in any structures so long as the liquid storage area can store therein the cigarette liquid.

The electric heating element 203 is for atomizing the cigarette liquid to generate smoke and is coiled spirally to form a plate-shape structure.

The electric heating element 203 is capable of atomizing the cigarette liquid to generate smoke which can be inhaled by a user.

Specifically, a plane where the electric heating element 203 locates may be perpendicular to or at a certain angle with respect to the axis of the atomizer cartridge 201.

For improving yield rate of products, facilitating the assembly and ensuring the volume of the smoke generated by atomization of the electric heating element 203 as large as possible, according to the embodiment, the plane where the electric heating element 203 locates is perpendicular to the axis of the atomizer cartridge 201.

Compared with the conventional electric heating wire which is wound into a column-shape structure, the spiral electric heating element 203 which forms the plate-shape structure according to the embodiment has a larger contact area with the liquid storage area 202, thus effectively increasing the smoke volume; in addition, one entire side of the electric heating element 203 close to the liquid storage area 202 is in contact with the liquid storage area 202, which avoids a conventional situation that a portion of the electric heating wire, which is not in contact with the liquid storage cotton, is burnt out.

For transferring the cigarette liquid stored in the liquid storage area 202 to the electric heating element 203 equably and constantly, the first liquid guide cloth 204, which is for transferring the cigarette liquid to the electric heating element 203 to get atomized, is provided covering an opening of the liquid storage area 202.

As illustrated in FIGS. 2 and 3, the electric heating element 203 is laid on one side of the first liquid guide cloth 204 away from the liquid storage area 202, and is arranged along a transverse direction of the atomizer.

Further, since the first liquid guide cloth 204 is arranged covering the electric heating element 203, when the electric heating element 203 reaches a high temperature during atomizing the cigarette liquid, heat of the electric heating element 203 may be dissipated uniformly through the first liquid guide cloth 204, to prevent the electric heating element 203 with an overly high temperature from burning components inside the liquid storage area 202. Hence, the user needs not to worry about failure of the atomizer due to burning-out of the components inside the liquid storage area 202 even when using the atomizer according to the present application for a long time.

Further, as illustrated in FIGS. 2 and 3, the electric heating element 203 is laid on the first liquid guide cloth 204 along a transverse direction of the atomizer, the electric heating element 203 spirals to form a plate-shape structure, and a first side face of the electric heating element 203 fits close to the surface of the first liquid guide cloth 204. In the embodiment, the electric heating element 203 is perpendicular to an axial direction of the atomizer. Alternatively, the electric heating element 203 may be arranged to form an angle bigger than 0 degree with respect to the axial direction of the atomizer, to generate a transverse arrangement, that is, the electric heating element 203 is arranged not to be parallel to the axial direction of the atomizer, which is not limited here. Furthermore, as illustrated in FIGS. 2 and 3, various portions of the electric heating element 203 according to the embodiment are all in a same plane. It may be appreciated that, the electric heating element 203 may be arranged to have various portions respectively in different planes, which is not limited here.

Since the electric heating element 203 is laid on the first liquid guide cloth 204, and the spiral electric heating element forms a plate-shape structure fitting close to the first liquid guide cloth 204, the length of the electric heating element 203 and the contact area between the electric heating element 203 and the first liquid guide cloth 204 are effectively increased. That is, it is achieved to arrange the electric heating element 203 having a large area on a small piece of first liquid guide cloth 204. Hence, the electric heating element 203, when working, may generate a large amount of smoke through atomization, and the user can inhale sufficient smoke, thereby ensuring the user experience. Since the electric heating element 203 is arranged in the atomizer transversely, spiral coils of the electric heating element 203 may not contact with each other due to gravity or vibration; hence, non-uniform smoke volume and burning-out caused by contact of spiral coils of the conventional electric heating element having a column-shape due to gravity or vibration are avoided and the yield rate of the products is increased.

It is to be noted that, the specific arrangement of the electric heating element 203 is not limited in the embodiment, so long as the electric heating element 203 can be laid on the first liquid guide cloth 204 and has a large area fitting close to the first liquid guide cloth 204.

In a second embodiment, the liquid storage area in the first embodiment is explained in detail.

Reference may be made to FIG. 2 for a first arrangement of the liquid storage area; this arrangement may be applied in a case that the atomizer is located at an end of an electronic cigarette body, the end being close to a suction end.

As illustrated in FIG. 2, the liquid storage area 202 includes:

a second liquid storage cotton 2011 which is accommodated inside the atomizer cartridge 201 and is for storing the cigarette liquid, where the first liquid guide cloth 204 is arranged covering an end face of the second liquid storage cotton 2011, the end face being close to the electric heating element 203.

Thus, the cigarette liquid stored inside the second liquid storage cotton 2011 is transferred to the electric heating element 203 via the first liquid guide cloth 204, for being atomized.

For timely discharging the smoke generated by atomization of the electric heating element 203, a smoke passage 2012 may be provided in a central position of the second liquid storage cotton 2011, where the smoke passage 2012 and the second liquid storage cotton are isolated from each other.

In the embodiment, a suction end 205 for discharging the smoke to be inhaled by the user is arranged on an end face of the atomizer cartridge 201, the end face being away from the electric heating element 203.

That is, the user may inhale, through the suction end 205, the smoke generated by atomization performed by the electric heating element 203.

In the embodiment, directions of airflow inside the atomizer are indicated by arrows in FIG. 2; that is, the airflow passes through the electric heating element 203, and accordingly, the smoke generated by atomization of the electric heating element 203 passes through the smoke passage 2012 and is inhaled by the user via the suction end 205.

Preferably, as illustrated in FIG. 4, for ensuring that the smoke flows smoothly, a first air hole 401 may further be provided on the electric heating element 203 and located at a position corresponding to that of the smoke passage 2012.

Furthermore, as shown in FIG. 3, for ensuring that the smoke discharged from the electric heating element 203 can flow to the suction end 205 smoothly, a second air hole 2041 may be provided in the central portion of the first liquid guide cloth 204, where the second air hole is located at a position corresponding to those of the first air hole 401 and the smoke passage 2012.

Thus, the smoke generated by atomization of the electric heating element 203 can smoothly flow to the smoke passage 2012 via the first air hole 401 and the second air hole 2041, to get inhaled by the user via the suction end 205.

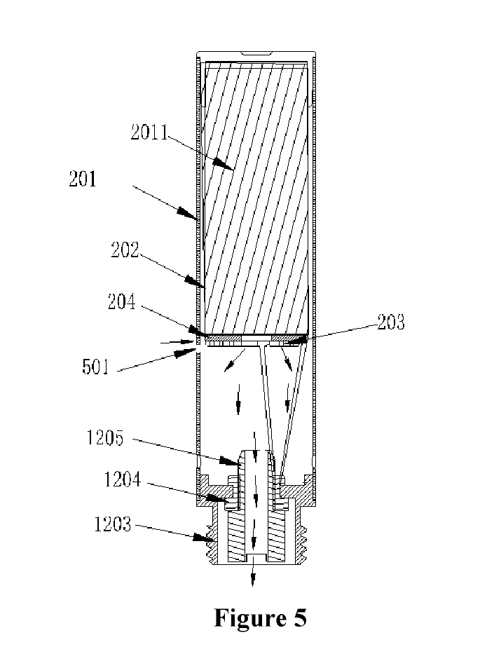

Reference may be made to FIG. 5 for a second arrangement of the liquid storage area. The arrangement may be applied in the case that the atomizer is located at an end of the electronic cigarette body, the end being away from the suction end.

In the arrangement, a second liquid storage cotton 2011 for storing the cigarette liquid is accommodated inside the atomizer cartridge 201, and the first liquid guide cloth 204 is arranged covering an end face of the second liquid storage cotton 2011, the end face being close to the electric heating element 203.

Thus, the cigarette liquid stored inside the second liquid storage cotton 2011 is transferred to the electric heating element 203 via the first liquid guide cloth 204, for being atomized.

Further, an air inlet 501 is arranged on an outer circumferential wall of the atomizer and is located at a position corresponding to that of the electric heating element 203.

The first liquid guide cloth 204 is arranged covering the electric heating element 203, specific function and effect are as described in the first arrangement, which are not described here.

In the arrangement, it is not required to provide a smoke passage inside the second liquid storage cotton 2011. In the embodiment, directions of airflow inside the atomizer may be indicated by arrows shown in FIG. 5; that is, the airflow enters into the atomizer via the air inlet 501 and passes by the electric heating element 203. Accordingly, the smoke generated by atomization of the electric heating element 203 flows in a direction away from the second liquid storage cotton 2011, flows into a battery rod assembly of the electronic cigarette, and reaches the suction end. Where, the suction end is located at an end of the battery rod, the end being away from the atomizer, and the user can inhale the smoke via the suction end.

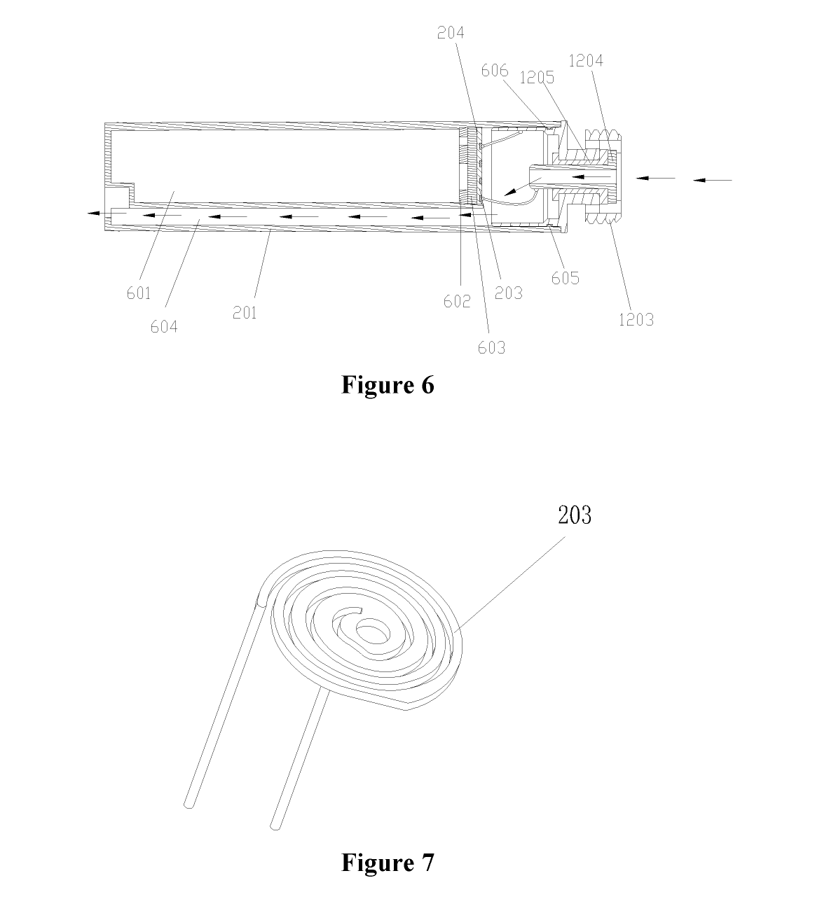

Reference may be made to FIG. 6 for a third arrangement of the liquid storage area. As illustrated in FIG. 6, a liquid storage chamber 601 for containing the cigarette liquid is provided inside the atomizer cartridge 201.

The cigarette liquid in liquid phase is stored inside the liquid storage chamber 601.

It is not required to provide a liquid storage cotton or a liquid guiding mechanism inside the liquid storage chamber 601 according to the embodiment, which enlarges space available for storing the cigarette liquid in the liquid storage chamber 601, increases the quantity of the cigarette liquid stored inside the liquid storage chamber 601, and effectively prolongs the duration of use of the electronic cigarette. The user does not need to frequently change the atomizer or add cigarette liquid into the liquid storage chamber 601, thus facilitating the use.

A liquid separation plate 602 having a first through hole is arranged at an opening of the liquid storage chamber 601. As illustrated in FIG. 6, the liquid separation plate 602 is arranged matching the opening of the liquid storage chamber 601, and the liquid separation plate 602 is provided with the first through hole. Hence, the cigarette liquid inside the liquid storage chamber 601 is transferred to the electric heating element 203 via the first through hole and may not be overly transferred to the electric heating element 203, thereby avoiding the leakage of the cigarette liquid and ensuring a uniform output of the cigarette liquid. In the embodiment, the liquid separation plate 602 may be detachably connected with the atomizer cartridge 201. Alternatively, the liquid separation plate 602 may be integrally formed with the atomizer cartridge 201.

A first liquid storage cotton 603 is arranged covering the liquid separation plate 602. The first liquid storage cotton 603 is for locking the cigarette liquid to prevent the cigarette liquid inside the liquid storage chamber 601 from being overly transferred to the electric heating element 203.

The first liquid storage cotton 603 is a sheet structure arranged along the transverse direction of the atomizer. The first liquid guide cloth is arranged covering a side face of the first liquid storage cotton 603, the side face being away from the liquid separation plate 602.

As illustrated in FIG. 6, the first liquid storage cotton 603 matches the liquid separation plate 602.

Preferably, the cigarette liquid can be equably and constantly transferred to the electric heating element 203 via the first liquid storage cotton 603, to ensure that the volume of the smoke generated by atomization of the electric heating element 203 is constant. The concentration of the smoke would not vary significantly and the experience of smoking of the user would not be negatively affected.

More preferably, it is not required to arrange the first liquid storage cotton 603 inside the liquid storage chamber 601; thus, the first liquid storage cotton does not occupy any space inside the liquid storage chamber 601, the volume of the liquid storage chamber 601 available for storing the cigarette liquid is increased, and accordingly, the quantity of the cigarette liquid stored in the atomizer is increased.

A first liquid guide cloth 204 is provided between the first liquid storage cotton 603 and the electric heating element 203.

The first liquid guide cloth 204 is made of a glass fiber material having good liquid guiding performance and heat resistive performance; hence, the reliability of the product is well ensured.

Further, for ensuring that the cigarette liquid can be equably transferred to the electric heating element 203 via the first liquid guide cloth 204, the first liquid guide cloth 204 is arranged covering the first liquid storage cotton 603, such that the cigarette liquid in the first liquid storage cotton 603 is equably transferred to the electric heating element 203 via the first liquid guide cloth 204.

The arrangement is described based on a case that the atomizer is located on the electronic cigarette body and is close to the suction end. In a case that the atomizer is located on the electronic cigarette body and is far away from the suction end, the structure of the atomizer is similar as that shown in FIG. 6, it is simply required to arrange an air inlet on the body of the atomizer at a position corresponding to that of the electric heating element 203, while the rest parts of the structure of the atomizer are the same as those described in the arrangement, which are not repeated here.

A passage 604 is provided inside the atomizer cartridge 204 and is isolated from the liquid storage chamber 601.

The airflow flows into the atomizer from the battery rod assembly. Directions of the airflow are indicated by arrows shown in FIG. 6. The airflow enters the atomizer and passes by the electric heating element 203; accordingly, the smoke generated by atomization of the electric heating element 203 flows through the passage 604 and reaches the suction end of the electronic cigarette, and then is inhaled by the user.

The specific structure of the liquid storage area is described in detail in the embodiment. It is to be noted that, the above description for the liquid storage area is merely exemplary and is not intended to limit the present application, so long as the liquid storage area can store the cigarette liquid and the electric heating element 203 can atomize the cigarette liquid to generate smoke.

In a third embodiment, the specific structure of the electric heating element 203 is described in detail.

The electric heating element 203 in the present application may be arranged with the following approaches.

Reference may be made to FIG. 4 for a first approach. Multiple sheet-like electric heating wires interconnected with each other are coiled to form the electric heating element 203 having a spiral sheet structure and the electric heating element is laid flat on the first liquid guide cloth 204, such that the electric heating element laid on the first liquid guide cloth 204 has a spiral structure. The spiral electric heating element 203 includes multiple interconnected spiral coils, and a gap 402, through which air or smoke can flow, is formed between any two interconnected spiral coils.

Reference may be made to FIG. 7 for a second approach. A flat metal block is directly punched to form an electric heating wire having a spiral sheet structure, and then the electric heating wire having the sheet structure is laid flat on the first liquid guide cloth 204, such that the electric heating element 203 laid on the first liquid guide cloth 204 has a spiral structure.

Compared with the first approach, the electric heating element 203 may be manufactured in a higher efficiency and a more reliable structure with the second approach.

It is to be noted that, ways to provide the electric heating element 203 with a sheet structure is not limited to punching, and the specific ways are not limited in the embodiment so long as the electric heating element 203 can be made into a sheet structure.

Furthermore, an air hole may be provided in a central portion of the electric heating element 203, such that the smoke generated by atomization of the electric heating element 203 can flow smoothly.

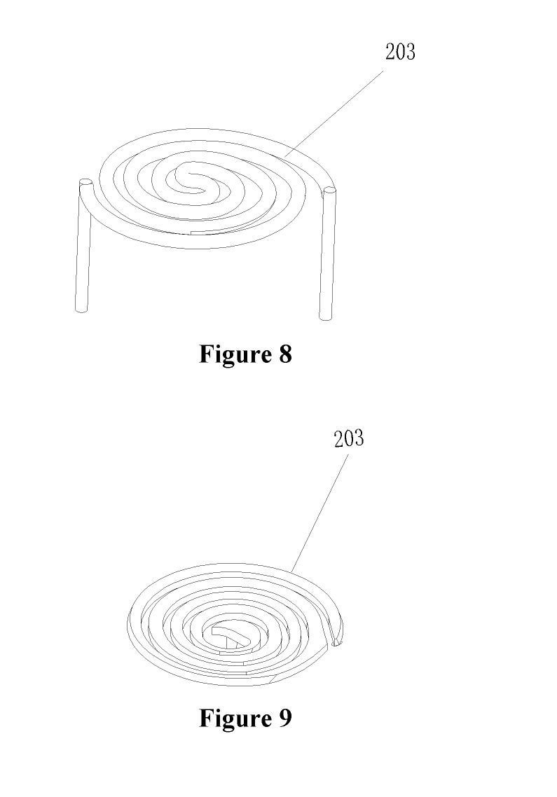

Reference may be made to FIG. 8 for a third approach. Two sheet-like electric heating wires are coiled parallelly to form the electric heating element having a double-spiral sheet structure, and the electric heating element is laid flat on the first liquid guide cloth 204;

or, a flat metal block is directly punched to form the electric heating wire having a double-spiral sheet structure, the double-spiral being formed by two spirals coiled parallelly, and then the sheet electric heating wire is laid flat on the first liquid guide cloth 204.

Compared with the first arrangement approach and the second arrangement approach, the contact area between the electric heating element 203 and the first liquid guide cloth 204 is further increased with this approach, thereby further ensuring a large volume of smoke.

Reference may be made to FIG. 9 for a fourth approach. On the basis of the first arrangement approach to the third arrangement approach, distances from respective spiral coils of the electric heating element 203 to the liquid storage area 202 gradually decrease from an innermost spiral coil of the electric heating element 203 to an outermost spiral coil of the electric heating element 203, such that an overall shape of the electric heating element 203 is a whirlpool.

A whirlpool angle of the whirlpool-shaped electric heating element 203 ranges from 0 degree to 90 degree, and when smoking, the smoke flows along the whirlpool; the electric heating element 203 performs the atomization constantly, which avoids or reduces the liquid leakage of the first liquid guide cloth 204 which is over saturated. In addition, the resistance and the power are large, a large volume of smoke can be generated instantly, thus meeting the user requirement for large volume of smoke.

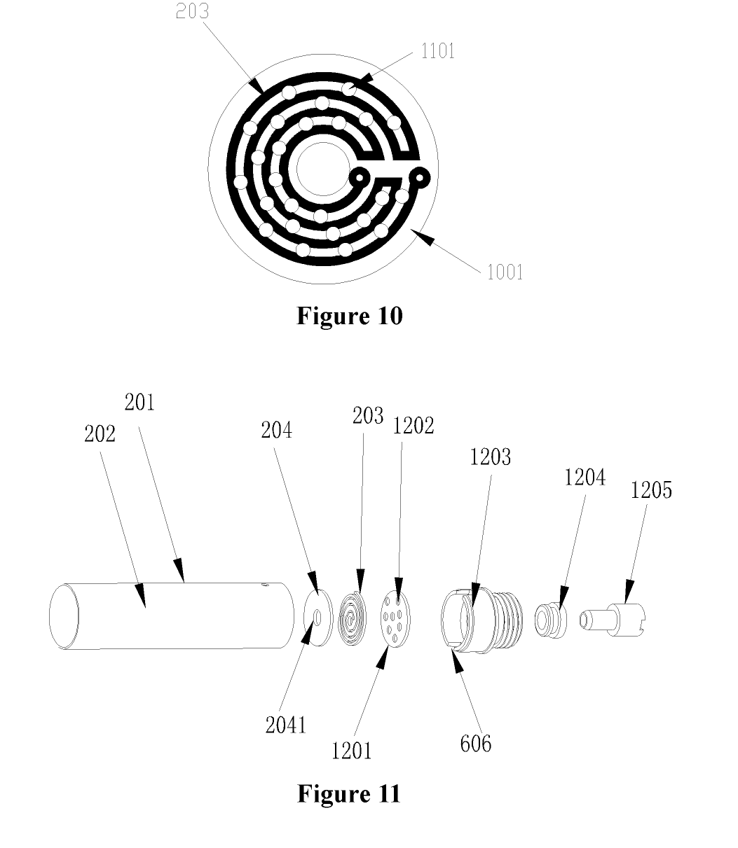

Reference may be made to FIG. 10 for a fifth arrangement approach,

in which, a substrate 1001 made of a heat resistive material is provided to abut against the liquid storage area 202.

Preferably, the substrate 1001 may be a Flexible Printed Circuit (abbreviated as FPC) board or a ceramic board, the specific material of the substrate is not limited in the embodiment, so long as the substrate 1001 has good heat resistive performance.

In the embodiment, the substrate 1001 is preferably an FPC board, which takes polyimide as a base material. Polyimide has high insulation performance, has no sharp melting point, and may resist a high temperature above 400 Celsius degrees, thus effectively avoiding the burning-out of the substrate 1001 due to high temperature of the electric heating element 203.

Specifically, the substrate 1001 has one side provided with a metal layer formed by printing or electroplating a metallic material on the substrate 1001 and serving as the electric heating element 203. In the embodiment, the metal layer is an alloy layer which is formed by multiple metallic materials.

More specifically, the alloy layer is a Fe—Cr alloy layer or a nichrome layer. The specific material is not limited in the embodiment, so long as the material can conduct electricity and the cigarette liquid can be accordingly atomized.

That is, a Fe—Cr alloy layer or a nichrome layer is firstly attached on the substrate 1001 by electroplating, and then a desired electric heating element 203 is formed by chemical erosion process or cutting. Alternatively, the metal layer may be directly printed on the substrate 1001 to form the electric heating element 203, which is not limited here.

More specifically, the alloy layer is provided on a side of the substrate 1001, the side being close to the liquid storage area 202.

It is to be noted that, the specific shape of the electric heating element 203 formed from the alloy layer is not limited in the embodiment, so long as the electric heating element 203 is spiral, and the contact area between the electric heating element 203 and the liquid storage area 202 can be as large as possible.

In the embodiment, it is to be noted that, the shape of the electric heating element 203 shown in FIG. 10 is merely exemplary, and the shape of the electric heating element is not limited thereto.

Apparently, the alloy layer may further be provided with an air hole for flowing of the smoke; and

the substrate 1001 is provided with a second through hole at a position corresponding to that of the air hole.

During the specific application, the electric heating element 203 formed from the alloy layer contacts with the liquid storage area 202 and atomizes the cigarette liquid stored inside the liquid storage area 202 to generate smoke; the generated smoke is discharged from the air hole on the electric heating element 203, and is discharged into the electronic cigarette body via the second through hole in the substrate 1001, to get inhaled by the user.

Furthermore, the substrate 1001 is provided with liquid permeating holes 1101 at positions corresponding to that of the alloy layer, where the liquid permeating holes are for transferring the cigarette liquid to the electric heating element.

During the specific application, the cigarette liquid inside the liquid storage area 202 is transferred to the electric heating element 203 via the liquid permeating holes 1101 of the substrate 1001, and then is atomized by the electric heating element 203 to generate smoke, and the smoke is discharged into the electronic cigarette body for being inhaled by the user.

With the arrangement approaches according to the embodiment, the temperature of the electric heating element 203 can be controlled in a range from 200 Celsius degrees to 320 Celsius degrees, thus avoiding the electric heating element 203 from burning out the first liquid guide cloth 204. Furthermore according to the embodiment, the contact area between the electric heating element 203 and the first liquid guide cloth 204 is big, such that a large quantity of cigarette liquid can be atomized, thus ensuring the volume of smoke for being inhaled by the user and improving the user experience.

Based on the third embodiment, in a fourth embodiment, a specific structure of an atomizer, in which the electric heating element 203 can atomize to obtain larger volume of smoke, is described in conjunction with FIG. 11.

As illustrated in FIG. 11, a second liquid guide cloth 1201 is further provided at a side of the electric heating element 203, the side being away from the first liquid guide cloth 204. The second liquid guide cloth 1201 covers the electric heating element 203, and the second liquid guide cloth 1201 abuts against the first liquid guide cloth 204 and is for transferring the cigarette liquid to the electric heating element 203 to get atomized.

Preferably, the first liquid guide cloth 204 and the second liquid guide cloth 1201 may be made of a glass fiber material capable of guiding liquid.

With the second liquid guide cloth 1201 according to the embodiment, both sides of the electric heating element 203 fit close to glass fiber cloths, such that both sides of the electric heating element 203 may atomize the cigarette liquid to generate smoke, thus further increasing the quantity of the cigarette liquid atomized by the electric heating element 203.

Still further, much heat may be generated during the electric heating element 203 atomizing the cigarette liquid to generate smoke, and if the heat generated during the atomizing can not be dissipated timely, the liquid guide cloth may be burnt out. In the embodiment, both sides of the electric heating element 203 fit close to the glass fiber cloths, the heat generated by the electric heating element 203 can be dissipated rapidly and timely through the first liquid guide cloth 204 and the second liquid guide cloth 1201, thereby effectively prevented the electric heating element 203 from burning out the first liquid guide cloth 204. The user experience is ensured, and the service life of the atomizer is effectively prolonged.

Further, the smoke generated through atomization of the electric heating element 203 may get condensed due to low temperature. If the smoke is condensed into the cigarette liquid, the cigarette liquid condensed may be inhaled by the user, thus negatively affecting the user experience during smoking. Therefore, it is required to timely discharge the smoke generated through atomization of the electric heating element 203, for being inhaled by the user.

In the embodiment, for ensuring sufficient and non-condensed smoke to be inhaled by the user, multiple smoke holes 1202 are provided on the second liquid guide cloth 1201.

Since the multiple smoke holes 1202 are provided on the second liquid guide cloth 1201, the smoke generated through atomization of the electric heating element 203 can pass be discharged rapidly through the smoke holes 1202. Furthermore, the arrangement of the smoke holes 1202 lead to better permeability during the discharging, which further increases the volume of the smoke generated by atomization of the electric heating element 203, and prevents the user from inhaling unatomized cigarette liquid while ensuring that the user can inhale sufficient volume of smoke.

In a fifth embodiment, an atomizer is provided which can effectively save the time consumed in assembling the atomizer, improve the efficiency of assembling the atomizer, save the manufacture cost, and lower requirements for assembly worker.

As shown in FIG. 11, the atomizer includes:

a first outer electrode 1203, an insulation ring 1204, and a first inner electrode 1205.

The first outer electrode 1203 is inserted in the atomizer cartridge 201.

Preferably, the first outer electrode 1203 is provided with a thread section, and through the thread section provided, the first outer electrode 1203 may be detachably connected with a battery rod assembly for supplying power for the atomizer.

The insulation ring 1204 is arranged inside the first outer electrode 1203.

The first inner electrode 1205 is inserted inside the insulation ring 1204.

That is, the insulation ring 1204 is arranged between the first outer electrode 1203 and the first inner electrode 1205.

In the embodiment, for simplifying the assembly process of the atomizer and improving the assembly efficiency, as illustrated in FIG. 5, the electric heating element 203 has one end inserted between the first outer electrode 1203 and the insulation ring 1204, and another end inserted between the first inner electrode 1205 and the insulation ring 1204.

That is, both ends of the electric heating element 203 extend and are respectively inserted into the area between the first outer electrode 1203 and the insulation ring 1204 and the area between the first inner electrode 1205 and the insulation ring 1204, to realize fixing of the electric heating element 203 inside the atomizer.

Alternatively, an electronic wire may further be welded at each of both ends of the electric heating element 203, and two electronic wires electrically connected to the electric heating element 203 are respectively inserted into the area between the first outer electrode 1203 and the insulation ring 1204 and the area between the first inner electrode 1205 and the insulation ring 1204.

It is to be noted that, the above arrangement is a preferred example, rather than a limit to the present application. To simplify the assembly, as illustrated in FIG. 6, the electric heating element 203 may have one end inserted into the area between the first outer electrode 1203 and the atomizer cartridge 201 and the other end inserted into the area between the first inner electrode 1205 and the insulation ring 1204. The specific arrangement of the insertion is not limited in the embodiment, so long as the first inner electrode 1205 and an atomizing electrode assembly are electrically connected by insertion rather than by welding.

With the insertion arrangement shown in the embodiment, the electric heating method 203 is electrically connected to the atomizing electrode assembly by insertion rather than by welding as in conventional technologies. During the specific assembling, it simply requires that two ends of the electric heating element 203 are to be respectively inserted into the area between the first outer electrode 1203 and the insulation ring 1204 and the area between the first inner electrode 1205 and the insulation ring 1204. The atomizer may be assembled without complicated operations, thus facilitating the assembly by the worker, improving the efficiency of the assembly, saving the manufacture cost, and lowering the requirements for the assembly worker.

Still further, as shown in FIG. 6, for ensuring the atomizer according to the embodiment with good sealing performance such that the cigarette liquid inside the liquid storage area 202 would not leak out, an annular protrusion 605 is provided on a circumferential surface of an inner wall of the atomizer cartridge 201 made of a non-metal material, and a groove 606 matching the protrusion 605 is provided on an outer circumferential surface of the first outer electrode 1203 at a position corresponding to that of the protrusion 605. Reference may be made to FIG. 11 for the specific structure of the groove 606.

Alternatively, for achieving good sealing performance of the atomizer, a first thread section may be arranged on the circumferential surface of the inner wall of the atomizer cartridge 201, and a second thread section is arranged on the outer circumferential surface of the first outer electrode at a position corresponding to that of the first thread section. The atomizer cartridge 201 is in thread connection with the first outer electrode 1203 through the thread cooperation between the first thread section and the second thread section, such that, the cigarette liquid inside the liquid storage area 202 would not leak out, the atomizer is ensured with good sealing performance.

Alternatively, an annular sealing plug may be provided at the opening of the liquid storage area 202 where abutting against the first outer electrode 1203, and with the annular sealing plug, the cigarette liquid inside the liquid storage area 202 would not leak out.

In a sixth embodiment, an electronic cigarette, in which the atomizer according to the foregoing embodiments is applied, is provided.

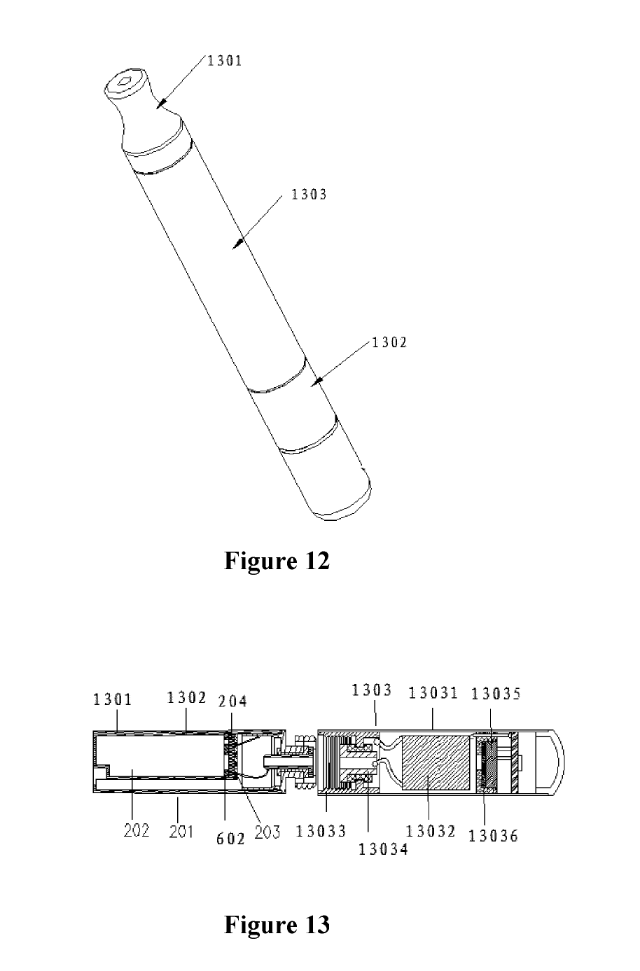

Reference may be made to FIG. 12. The electronic cigarette includes an electronic cigarette body. The electronic cigarette body is provided with a suction end 1301, an atomizer 1302 as described in the above embodiments, and a battery rod assembly 1303 for supplying power for the atomizer 1302. The atomizer 1302 is coaxially arranged with the battery rod assembly 1303, and the atomizer 1302 is detachably connected with the battery rod assembly 1303. With such arrangement, the appearance of the electronic cigarette visually imitates a tobacco cigarette; and an overall smoke passage is relatively straight, which may reduce liquid accumulation effectively.

Specifically, as shown in FIG. 12, the atomizer 1302 is arranged at one end of the electronic cigarette body, the end being away from the suction end 1301.

Advantages of employing such an arrangement method lie as follows. Since the atomizer 1302 is arranged away from the suction end 1301, the smoke passage for flowing of the smoke inside the electronic cigarette body may not pass by the atomizer 1302; therefore, the cigarette liquid inside the atomizer 1302, which is not atomized, may not leak into the smoke passage, and the user may not inhale the unatomized cigarette liquid, thus effectively avoiding leakage of the cigarette liquid. Furthermore, since the smoke passage does not pass through the atomizer 1302, the smoke is avoided from condensing in the smoke passage, thereby effectively preventing the condensed cigarette liquid from blocking the smoke passage.

Since the atomizer 1302 is located away from the suction end 1301, when the user puffs on the electronic cigarette according to the embodiment, the atomizer 1302 is relatively far from the mouth of the user. Hence, the user is protected from getting burnt by the heat generated when the atomizer 1302 atomizes the cigarette liquid, which effectively improves safety in using the electronic cigarette. Furthermore, the user may usually clamps the battery rod assembly 1303 rather than the hot atomizer 1302 during smoking, such that the hand of the user may not be burnt when the user uses the electronic cigarette according to the embodiment, thereby effectively imitating the temperature of a tobacco cigarette and improving user experience during smoking.

Specifically, the suction end 1301 is formed by an extension of one end of the battery rod assembly 1303, the end being away from the atomizer; or the suction end 1301 is detachably connected to the end of the battery rod assembly 1303 away from the atomizer 1302.

Preferably, the suction end may be designed to match the mouth shape of the user, thus further facilitating the user smoking and improving the user experience during smoking.

The above arrangement approach of the electronic cigarette body is a preferred arrangement approach, but the electronic cigarette body is not limited to the above arrangement approach. For example, the battery rod assembly may be arranged at one end of the electric cigarette body, the end being far away from the suction end. In such arrangement approach, the suction end is formed by an extension of one end of the atomizer, the end being far away from the battery rod assembly; or the suction end is detachably connected to the end of the atomizer far away from the battery rod assembly.

The overall outline of the electronic cigarette body may be arranged in an irregular shape, which may be a random shape specifically. Alternatively, the atomizer may be arranged non-coaxially with the battery rod assembly; that is, the atomizer and the battery rod assembly are abreast arranged, such that the overall structure of the electronic cigarette may be in a T-shape.

For facilitating the user to replace the atomizer 1302, the atomizer 1302 is detachably connected with the battery rod assembly 1203. Specifically, a snap-fit approach or a thread connection may be adopted to detachably connect the atomizer 1302 and the battery rod assembly 1303.

Reference may be made to FIG. 13, which is a schematic sectional view showing the structure of an electronic cigarette according to another embodiment of the present application. Reference may be made to the above embodiments for the specific structure of the atomizer shown in FIG. 13, which is not repeated in the embodiment.

The battery rod assembly 1303 includes a battery cartridge 13031, a battery 13032, a second outer electrode 13033, a second inner electrode 13034, a sensor module 13035, and a microcontroller 13036.

The battery 12032 is accommodated inside the battery cartridge 13031.

The second outer electrode 13033 and the second inner electrode 13034 are respectively electrically connected with the battery 13032, where the second outer electrode 13033 is electrically connected to the first outer electrode 1203, and the second inner electrode 13034 is electrically connected to the first inner electrode 1205.

The sensor module 13035 is for generating a triggering signal in response to an operation of the user.

Specifically, in the embodiment, the sensor module 13035 is an airflow sensor switch which senses a sucking action of the user to generate a triggering signal.

The microcontroller 13036, which is for generating a control signal based on the triggering signal, is electrically connected to the sensor module 13035; and the microcontroller 13036 controls, through the control signal, the battery 13032 to supply power for the electric heating element 203.

The technical solutions in the embodiments of the present application are described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the protection scope of the present application.

The above embodiments are described in a progressive manner. Each of the embodiments is mainly focused on describing its differences from other embodiments, and references may be made among these embodiments to understand the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

What is claimed is:

1. An atomizer, comprising:
an atomizer cartridge;
a liquid storage area which is arranged inside the atomizer cartridge and is configured to store a cigarette liquid;
an electric heating element which is configured to atomize the cigarette liquid to generate smoke and is coiled spirally to form a plate-shape structure; and
a first liquid guide cloth configured to transfer the cigarette liquid to the electric heating element to be atomized;
wherein the first liquid guide cloth is arranged covering an opening of the liquid storage area, the electric heating element is laid on a side of the first liquid guide cloth, the side of the first liquid guide cloth being away from the liquid storage area, and the electric heating element is arranged along a transverse direction of the atomizer.

2. The atomizer according to claim 1, wherein a second liquid guide cloth is further provided at a side of the electric heating element, the side of the electric heating element being away from the first liquid guide cloth, the second liquid guide cloth covers the electric heating element, and the second liquid guide cloth abuts against the first liquid guide cloth and is configured to transfer the cigarette liquid to the electric heating element to be atomized.

3. The atomizer according to claim 1, wherein the liquid storage area comprises:
a liquid storage chamber, which is arranged inside the atomizer cartridge and is configured to contain the cigarette liquid;
a liquid separation plate, which is arranged at an opening of the liquid storage chamber and is provided with a first through hole; and
a first liquid storage cotton, which is arranged covering the liquid separation plate and is configured to lock the cigarette liquid to prevent the cigarette liquid inside the liquid storage chamber from being overly transferred to the electric heating element; wherein the first liquid storage cotton is a sheet structure arranged along the transverse direction of the atomizer, and the first liquid guide cloth is arranged on a side face of the first liquid storage cotton, the side face of the first liquid storage cotton being away from the liquid separation plate, or,
a second liquid storage cotton, which is accommodated inside the atomizer cartridge and is configured to store the cigarette liquid, wherein the first liquid guide cloth is arranged covering an end face of the second liquid storage cotton, the end face of the second liquid storage cotton being close to the electric heating element.

4. The atomizer according to claim 1, further comprising:
a substrate made of a heat resistive material, wherein the substrate abuts against a side of the first liquid guide cloth, the side of the first liquid guide cloth being away from the liquid storage area;
wherein the substrate has a side provided with a metal layer formed by printing or electroplating a metallic material on the substrate and serving as the electric heating element.

5. The atomizer according to claim 4, wherein the metal layer is an alloy layer made of a plurality of metallic materials.

6. The atomizer according to claim 5, wherein
the alloy layer is provided at a side of the substrate, the side of the substrate being close to the liquid storage area;
the alloy layer is provided with an air hole for flowing of the smoke; and
the substrate is provided with a second through hole at a position corresponding to that of the air hole.

7. The atomizer according to claim 5, wherein
the alloy layer is provided at a side of the substrate, the side of the substrate being away from the liquid storage area; and
the substrate is provided with a liquid permeating hole at a position corresponding to that of the alloy layer, wherein the liquid permeating holes are for transferring the cigarette liquid to the electric heating element.

8. The atomizer according to claim 1, further comprising:
a first outer electrode inserted in the atomizer cartridge;
an insulation ring arranged inside the first outer electrode; and
a first inner electrode inserted inside the insulation ring;
wherein the electric heating element has one end inserted between the first outer electrode and the insulation ring, and another end inserted between the first inner electrode and the insulation ring.

9. The atomizer according to claim 1, wherein distances from respective spiral coils of the electric heating element to the liquid storage area gradually decrease from an innermost spiral coil of the electric heating element to an outermost spiral coil of the electric heating element.

10. The atomizer according to claim 1, wherein the atomizer cartridge is made of a non-metallic material, an annular protrusion is provided on a circumferential surface of an inner wall of the atomizer cartridge, and a groove matching the protrusion is provided on an outer circumferential surface of the first outer electrode at a position corresponding to that of the protrusion.

11. The atomizer according to claim 4, wherein the substrate is a flexible printed circuit board or a ceramic board.

12. The atomizer according to claim 1, wherein at least one of the first liquid guide cloth and the second liquid guide cloth is a glass fiber cloth made of a glass fiber material.

13. An electronic cigarette, comprising an electronic cigarette body; wherein the electronic cigarette body is provided with a suction end, an atomizer, and a battery rod assembly for supplying power for the atomizer; and
the battery rod assembly is arranged at an end of the electronic cigarette body, the end of the electronic cigarette body being away from the suction end; or the atomizer is arranged at an end of the electronic cigarette body, the end of the electronic cigarette body being away from the suction end;
wherein the atomizer comprises:
an atomizer cartridge;
a liquid storage area which is arranged inside the atomizer cartridge and is configured to store a cigarette liquid;
an electric heating element which is configured to atomize the cigarette liquid to generate smoke and is coiled spirally to form a plate-shape structure; and
a first liquid guide cloth configured to transfer the cigarette liquid to the electric heating element to be atomized;
wherein the first liquid guide cloth is arranged covering an opening of the liquid storage area, the electric heating element is laid on a side of the first liquid guide cloth, the side of the first liquid guide cloth being away from the liquid storage area, and the electric heating element is arranged along a transverse direction of the atomizer.

14. The electronic cigarette according to claim 13, wherein
the atomizer is coaxially arranged with the battery rod assembly, and the atomizer is detachably connected with the battery rod assembly.

15. The electronic cigarette according to claim 13, wherein the battery rod assembly comprises:
a battery cartridge;
a battery accommodated inside the battery cartridge;
a second outer electrode and a second inner electrode respectively electrically connected with the battery, wherein the second outer electrode is electrically connected with the first outer electrode, and the second inner electrode is electrically connected with the first inner electrode;
a sensor module configured to generate a triggering signal in response to an operation of the user; and
a microcontroller which is electrically connected with the sensor module and is configured to generate a control signal based on the triggering signal, wherein the microcontroller controls, through the control signal, the battery to supply power for the electric heating element.

16. The electronic cigarette according to claim 13, wherein
the suction end is formed by an extension of one end of the atomizer, the end of the atomizer being away from the battery rod assembly; or,
the suction end is detachably connected to one end of the atomizer, the end of the atomizer being away from the battery rod assembly.

17. The electronic cigarette according to claim 13, wherein
the suction end is formed by an extension of one end of the battery rod assembly, the end of the battery rod assembly being away from the atomizer; or,
the suction end is detachably connected to one end of the battery rod assembly, the end of the battery rod assembly being away from the atomizer.

18. The atomizer according to claim 2, wherein at least one of the first liquid guide cloth and the second liquid guide cloth is a glass fiber cloth made of a glass fiber material.
